(19) United States
(12) Patent Application Publication
(10) Pub. No.: US 2016/0260184 A1
(43) Pub. Date: Sep. 8, 2016

(54) DOCUMENT INVESTIGATION SYSTEM, DOCUMENT INVESTIGATION METHOD, AND DOCUMENT INVESTIGATION PROGRAM FOR PROVIDING PRIOR INFORMATION

(71) Applicant: UBIC, INC., Tokyo (JP)

(72) Inventors: Masahiro MORIMOTO, Tokyo (JP); Hideki TAKEDA, Tokyo (JP); Kazumi HASUKO, Tokyo (JP)

(21) Appl. No.: 14/916,142

(22) PCT Filed: Mar. 17, 2014
(86) PCT No.: PCT/JP2014/057108

§ 371 Date: Apr. 15, 2016

(30) Foreign Application Priority Data
Sep. 6, 2013 (JP) 2013-184604

(51) Int. Cl. G06Q 50/18; G06F 17/30

(52) U.S. Cl. CPC G06Q 50/18; G06F 17/30011

(57) ABSTRACT

A document investigation system, method, and program for conducting precise and reliable investigations depending on a lawsuit case and reducing burdens on work to investigate the relevant document information are provided.

A computer: analyzes case-investigation-result-related information with respect to each lawsuit case; prepares or updates, and registers an investigation model parameter(s) to investigate the lawsuit case; extracts an investigation model parameter from the registered investigation model parameters in relation to input information for specifying the investigation content of a new investigation case; outputs an investigation model by using the extracted investigation model parameter; and configures and provides prior information to investigate the new investigation case based on the investigation model output result.

### TECHNICAL FIELD

The present invention relates to a document investigation system, a document investigation method, and a document investigation program. Particularly, the invention relates to a document investigation system, document investigation method, and document investigation program for providing prior information to classify and investigate documents depending on a lawsuit case or a fraud investigation case.

### BACKGROUND ART

Conventionally, when a crime or a legal conflict relating to computers such as unauthorized access or leakage of confidential information occurs, there have been proposed means or techniques that collect and analyze equipment, data, and electronic records required for investigation into the cause of the crime or legal conflict and clarify legal evidences of the crime or legal conflict.

Particularly, procedures such as eDiscovery (electronic discovery) are required for a civil lawsuit in the United State of America and both a plaintiff and a defendant involved in the lawsuit are liable to submit all pieces of related digital information as evidences. Therefore, they need to submit digital information recorded in computers and/or servers as the evidences.

Meanwhile, due to the rapid development and spreading of information technologies, most information in today's business world is produced by computers, so that digital information is abundant even within the same company.

Therefore, in the preparatory work of gathering evidentiary materials to be submitted to a court of law, mistakes can easily occur where even confidential digital information, which is not necessarily related with the relevant lawsuit, may be included in the evidentiary materials. Another problem is that confidential document information which is not related to the relevant lawsuit is submitted.

In recent years, techniques related to document information in forensic systems have been proposed in PTL 1 to PTL 3. PTL 1 discloses a forensic system that: designates a specific person from at least one or more users included in user information; extracts only digital document information which is accessed by the specific person on the basis of access history information about the designated specific person; sets accessory information indicating whether each document file of the extracted digital document information is related to a lawsuit or not; and outputs the document files related to the lawsuit on the basis of the accessory information.

Furthermore, PTL 2 discloses a forensic system that: displays recorded digital information; sets user-identifying information indicating to which one of users included in user information each of a plurality of document files is related; sets settings so that the set user-identifying information will be recorded in a storage unit; designates at least one or more users; searches for a document file in which the user-specifying information corresponding to the designated user is set; sets accessory information indicating whether the searched document file is related to a lawsuit or not, on a display unit; and outputs the document file related to the lawsuit on the basis of the accessory information.

Furthermore, PTL 3 discloses a forensic system that: receives designation of at least one or more document files included in digital document information; receives designation indicating into which language the designated document file should be translated; translates the designated document file into the designated language; extracts a common document file indicating the same content as the designated document file from the digital document information recorded in a recording unit; generates translation-related information indicating that the extracted common document file is translated by employing the translation content of the translated document file; and outputs a document file related to a lawsuit on the basis of the translation-related information.

### CITATION LIST

### Patent Literature

PTL 1: Japanese Patent Application Laid-Open (Kokai) Publication No. 2011-209930

PTL 2: Japanese Patent Application Laid-Open (Kokai) Publication No. 2011-209931

PTL 3: Japanese Patent Application Laid-Open (Kokai) Publication No. 2012-32859

### SUMMARY OF INVENTION

### Problems to be Solved by the Invention

However, for example, the forensic systems like those described in PTL 1 to PTL 3 would collect an enormous amount of document information of users who use a plurality of computers and servers.

Regarding work to classify whether such an enormous amount of digitalized document information is valid as evidential materials for a lawsuit or not, a user called a “reviewer” needs to visually check and classify each piece of the relevant document information, thereby causing a problem requiring a large amount of labor and cost.

So, in light of the above-described circumstances, it is an object of the present invention to provide a document investigation system, document investigation method, and document investigation program for conducting precise and reliable investigations depending on a lawsuit case or a fraud investigation case and providing prior information that reduces burdens on classification work and investigation work conducted with respect to the relevant document information.

### Means for Solving the Problems

A document investigation system for providing prior information according to the present invention is a document investigation system for acquiring digital information recorded in a plurality of computers or servers, analyzing document information composed of a plurality of documents included in the obtained digital information, and providing prior information to investigate relevance with a lawsuit or fraud investigation in order to make it easier to use the document information for the lawsuit or the fraud investigation, wherein the document investigation system for providing the prior information includes: an investigation result analysis unit that collects and analyzes case-investigation-result-related information including a classification work result of each case with respect to a lawsuit or fraud investigation case, prepares or updates an investigation model parameter to investigate the lawsuit or fraud investigation case, and registers the investigation model parameter; and a prior information configuration unit that, after accepting input information for specifying investigation content of a new investigation case, searches for the registered investigation model parameter, extracts an investigation model parameter in relation to the input information, outputs an investigation model by using the extracted investigation model parameter, and configures and provides the prior information to investigate the new investigation case based on an investigation model output result.

A document investigation method for providing prior information according to the present invention is a document investigation method for acquiring digital information recorded in a plurality of computers or servers, analyzing document information composed of a plurality of documents included in the obtained digital information, and providing prior information to investigate relevance with a lawsuit or fraud investigation in order to make it easier to use the document information for the lawsuit or the fraud investigation: collect and analyze case-investigation-result-related information including a classification work result of each case with respect to a lawsuit or fraud investigation case, prepare or update an investigation model parameter to investigate the lawsuit or fraud investigation case, and register the investigation model parameter; and after accepting input information for specifying investigation content of a new investigation case, search for the registered investigation model parameter, extracts an investigation model parameter in relation to the input information, output an investigation model by using the extracted investigation model parameter, and configure and provide the prior information to investigate the new investigation case based on an investigation model output result.

A document investigation program for providing prior information according to the present invention is a document investigation program for acquiring digital information recorded in a plurality of computers or servers, analyzing document information composed of a plurality of documents included in the obtained digital information, and providing prior information to investigate relevance with a lawsuit or fraud investigation in order to make it easier to use the document information for the lawsuit or the fraud investigation, wherein the document investigation program has the computers implement: a function that collects and analyzes case-investigation-result-related information including a classification work result of each case with respect to a lawsuit or fraud investigation case, prepares or updates an investigation model parameter to investigate the lawsuit or fraud investigation case, and registers the investigation model parameter; and a function that, after accepting input information for specifying investigation content of a new investigation case, searches for the registered investigation model parameter, extracts an investigation model parameter in relation to the input information, outputs an investigation model by using the extracted investigation model parameter, and configures and provides the prior information to investigate the new investigation case based on an investigation model output result.

Specific terms will be explained below in order to facilitate understanding of the document investigation system, document investigation method, and document investigation program for providing the prior information according to the present invention.

“Case-investigation-result-related information” means a combination of: information that is collected for each case, on which classification or investigations are conducted, and specifies a case type, an investigation type, or a language type; bibliographic information about investigation target documents; statistic information about the investigation target documents; review-related information (such as protocols); review result information; predictive coding (PC) parameters and result information; or feedback information.

An “investigation model(s)” is a model(s) indicative of typical characteristic acts (fraudulent acts, quasi-fraudulent acts, and dangerous acts) of an investigation target. There are a plurality of models, which may be selected as appropriate, depending on, for example, an investigation type.

An “investigation model parameter(s)” is a parameter(s) in an investigation model for defining the “investigation model.” A “common information element(s)” is extracted when information about a “new case” is registered; and the “investigation model parameter” is determined (added, deleted, or updated) based on this information related to this “common information element(s).”

“Investigation model output” means that an investigation model parameter that matches a new case is extracted from investigation model parameters which are registered for the new case and a specified proportion of documents for the new case are analyzed by an investigation model defined by the extracted investigation model parameter.

### Advantageous Effects of Invention

The document investigation system, document investigation method, and document investigation program for providing the prior information according to the present invention can make it possible to conduct precise and reliable classification and investigations depending on a lawsuit case or a fraud investigation case and reduce burdens on work to classify and investigate document information by collecting and analyzing information, which has been accumulated in relation to a lawsuit case or a fraud investigation case, in advance depending on the lawsuit case or fraud investigation case and conducting the classification work and investigation work with respect to the document information to be used for the lawsuit or fraud investigation based on the analyzed information.

### BRIEF DESCRIPTION OF DRAWINGS

FIG. 1 is a configuration diagram of a document investigation system according to an embodiment of the present invention;

FIG. 2 is a chart illustrating a processing flow of a document investigation method according to an embodiment of the present invention;

FIG. 3 is a chart illustrating a processing flow in each stage of an embodiment;

FIG. 4 is a chart illustrating a processing flow of a keyword database according to an embodiment;

FIG. 5 is a chart illustrating a processing flow of a related term database according to this embodiment;

FIG. 6 is a chart illustrating a processing flow of a first automatic classification unit according to this embodiment;

FIG. 7 is a chart illustrating a processing flow of a second automatic classification unit according to this embodiment;

FIG. 8 is a chart illustrating a processing flow of a classification code accepting and assigning unit according to this embodiment;

FIG. 9 is a chart illustrating a processing flow of a document analysis unit according to this embodiment;

FIG. 10 is a graph illustrating an analysis result by a document analysis unit according to this embodiment;

FIG. 11 is a chart illustrating a processing flow of a third automatic classification unit according to one example of this embodiment;

FIG. 12 is a chart illustrating a processing flow of a third automatic classification unit according to another example of this embodiment;

FIG. 13 is a chart illustrating a processing flow of a quality checking unit according to this embodiment; and

FIG. 14 is a document display screen according to this embodiment.

### DESCRIPTION OF EMBODIMENTS

### Embodiments of the Present Invention

A document investigation system according to an embodiment of the present invention acquires digital information recorded in a plurality of computers or servers, analyzes document information composed of a plurality of documents included in the obtained digital information, and assigns classification codes indicative of the relevance with a lawsuit to the documents, thereby facilitating the use of such documents in the lawsuit.

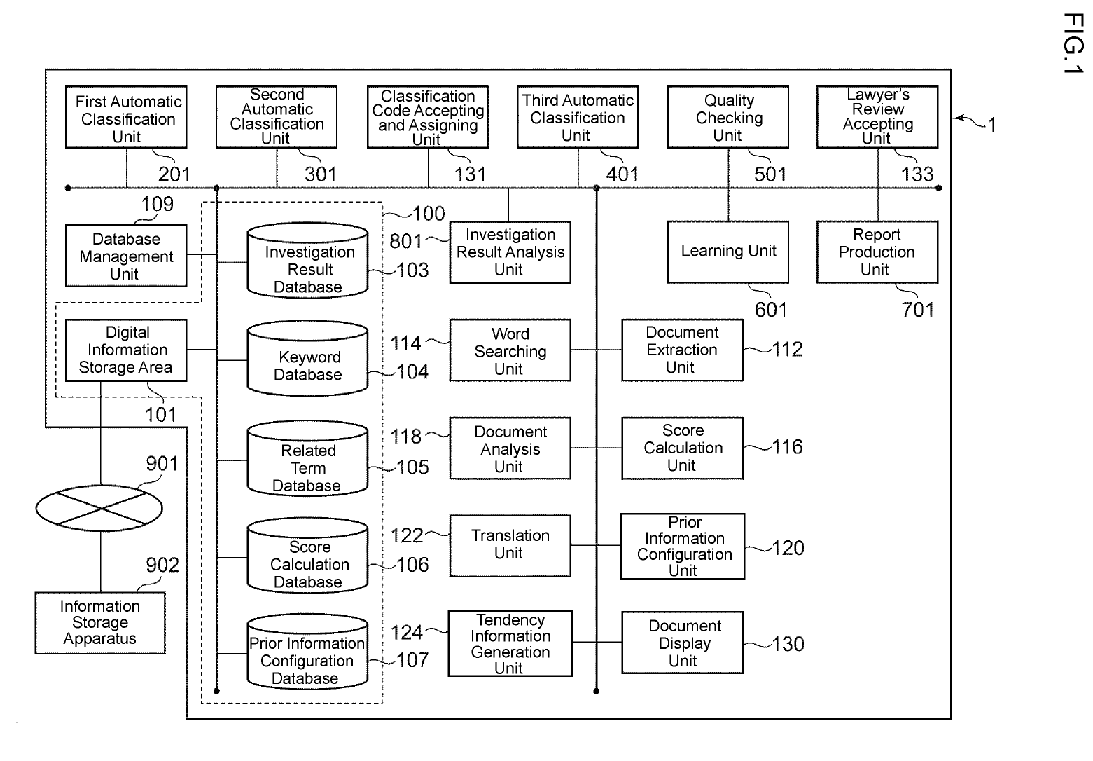

FIG. 1 illustrates the configuration of the document investigation system according to an embodiment of the present invention. The configuration of the document investigation system according to the embodiment of the present invention will be described with reference to FIG. 1.

A document investigation system 1 according to the embodiment includes a data storage unit 100 that stores information and data. The data storage unit 100 stores digital information, which is obtained from a plurality of computers or servers, in a digital information storage area 101 in order to use the digital information for analysis of a lawsuit or fraud investigation.

Then, the data storage unit 100 stores: an investigation result database 103 which stores the case-investigation-result-related information and analysis result related to the classification and investigation result of each case; a keyword database 104 in which specified classification codes of documents included in the obtained digital information, keywords closely related to the specified classification codes, and keyword-corresponding information indicative of the correspondence relationship between the specified classification codes and the keywords are registered; a related term database 105 in which specified classification codes, related terms composed of words appearing at high appearance frequency in documents to which the specified classification codes are assigned, and related-term-corresponding information indicative of the correspondence relationship between the specified classification codes and the related terms are registered; and a score calculation database 106 in which weightings of words included in the relevant documents are registered to calculate a score indicative of linkage strength between the documents and the classification codes. Furthermore, the data storage unit 100 stores a prior information configuration database 107 in which information about a predictive coding created for each case is registered. This data storage unit 100 may be installed in the document investigation system 1, as illustrated in FIG. 1, or installed as a separate storage apparatus outside the document investigation system 1.

The document investigation system 1 according to the embodiment of the present invention is equipped with a database management unit 109 that manages updates of data content of the investigation result database 103, the keyword database 104, the related term database 105, the score calculation database 106, and the prior information configuration database 107. The content of data stored in an information storage apparatus 902 may be transferred to, and incorporated into, the digital information storage area 101 via a dedicated connection line or Internet connection 901. Then, the database management unit 109 may update the data content of the investigation result database 103, the keyword database 104, the related term database 105, the score calculation database 106, and the prior information configuration database 107 on the basis of the information transferred from the information storage apparatus 902 to the digital information storage area 101.

The document investigation system 1 according to the embodiment of the present invention is equipped with: a document extracting unit 112 that extracts a plurality of documents from document information; a word searching unit 114 that searches the document information for the keywords or related terms recorded in the databases; and a score calculation unit 116 that calculates a score indicative of the linkage strength between the documents and the classification codes.

The document investigation system 1 according to the embodiment of the present invention includes: a first automatic classification unit 201 that has the word searching unit 114 search for keywords recorded in the keyword database 104, extracts documents including the keywords from the document information, and automatically assigns specified classification codes to the extracted documents on the basis of the keyword-corresponding information; and a second automatic classification unit 301 that extracts documents, which includes related terms recorded in the related term database, from the document information, calculates the score on the basis of an evaluation value of the related terms included in the extracted documents and the number of the related terms, and automatically assigns a specified classification code to a document whose score exceeds a certain value, from among the documents including the related terms, on the basis of the score and the related-term-corresponding information.

Furthermore, the document investigation system 1 according to the embodiment is equipped with: a document display unit 130 that displays a plurality of documents extracted from the document information on a screen; a classification code accepting and assigning unit 131 that accepts classification codes assigned by a user to a plurality of documents, which are extracted from the document information and to which no classification code is assigned, on the basis of the relation with the lawsuit and assigns the classification codes; a document analysis unit 118 that analyzes the documents to which the classification codes are assigned by the classification code accepting and assigning unit 131; and a third automatic classification unit 401 that automatically assigns the classification codes to the plurality of documents extracted from the document information on the basis of an analysis result of the documents to which the classification codes were assigned by the classification code accepting and assigning unit 131 and which have been analyzed by the document analysis unit 118.

Furthermore, the document investigation system 1 according to the embodiment of the present invention is equipped with: an investigation result analysis unit 801 that collects and analyzes information related to the lawsuit or fraud investigation case; and a prior information configuration unit 120 that configures the prior information from the analysis result of the case-investigation-result-related information.

The investigation result analysis unit 801 collects and analyzes the case-investigation-result-related information including the case type, the investigation type, the language type, the classification work result, and the predictive classification work result of each case with respect to the lawsuit or fraud investigation case. Next, the investigation result analysis unit 801 creates or updates an investigation model(s) and an investigation model parameter(s) to investigate the lawsuit or fraud investigation case on the basis of the analysis result of the investigation-result-related information. Then, the investigation result analysis unit 801 registers the case-investigation-result-related information, the analysis result of the case-investigation-result-related information, the investigation model(s), and the investigation model parameter(s) in the investigation result database 103.

After accepting input information for specifying the investigation content of a new investigation case, the prior information configuration unit 120 searches the investigation result database 103, extracts an investigation model and an investigation model parameter from the investigation result database 103 in relation to the input information, outputs the investigation model by using the extracted investigation model and investigation model parameter, and configures prior information from the investigation model output result to investigate the new investigation case. The prior information configuration unit 120 may register the new investigation case, the investigation model parameter, the investigation model output result, and the prior information in the prior information configuration database 107.

After the prior information is issued and output from the prior information configuration unit 120, the first automatic classification unit 201, the second automatic classification unit 301, and the third automatic classification unit 401 of the document investigation system 1 according to the embodiment classify the extracted document information in accordance with classification and investigation conditions set by the prior information.

Furthermore, the document investigation system 1 according to the embodiment of the present invention may be equipped with a translation unit 122 that translates the executed documents when accepting designation by the user or automatically. The translation unit 122 may set language breaks at every unit shorter than one sentence so that it can deal with combined languages wherein multiple languages are used in one sentence. Moreover, either predictive coding or character coding for language identification, or both of them, may be used to identify the language(s). Furthermore, processing for excluding, for example, headers of HTML from translation objects may be executed.

Furthermore, in order to have the document analysis unit 118 conduct the analysis, the document investigation system 1 according to the embodiment of the present invention may be equipped with a tendency information generation unit 124 that generates tendency information indicative of the degree of similarity between documents, to which the classification code of each document is assigned, on the basis of types of words included in each document, the number of appearances, and evaluation values of the words.

Moreover, the document investigation system 1 according to the embodiment of the present invention may be equipped with a quality checking unit 501 that compares a classification code accepted by the classification code accepting and assigning unit 131 with a classification code assigned by the document analysis unit 118 according to the tendency information and thereby verifies the validity of the classification code accepted by the classification code accepting and assigning unit 131.

Furthermore, the document investigation system according to the embodiment of the present invention may be equipped with a learning unit 601 that learns weighting of each keyword or related term on the basis of the result of document classification processing or predictive document classification processing.

The document investigation system 1 according to the embodiment of the present invention is equipped with a report preparation unit 701 that outputs an optimum investigation report according to the investigation type of the relevant lawsuit case or the fraud investigation on the basis of the result of the document classification processing. Lawsuit cases include, for example, antitrust (cartel), patent, Foreign Corrupt Practices Act (FCPA), or Product Liability (PL) lawsuits. Furthermore, fraud investigations include, for example, investigations of information leakage or billing fraud.

The document investigation system 1 according to the embodiment of the present invention is equipped with a lawyer's review accepting unit 133 that accepts a chief attorney's or chief patent attorney's review in order to enhance the quality of the classification investigation and the report and clarify the liability for the classification investigation and the report.

Terms specific to the embodiment will be described below in order to facility the understanding of the document investigation system according to the embodiment of the present invention.

A “classification code(s)” is an identifier which is used to classify documents and is indicative of the relevance with a lawsuit in order to make it easier to use the documents in the lawsuit. For example, when the document information is used as evidence in the lawsuit, the classification code may be assigned depending on the type of the evidence.

A “document(s)” is data including one or more words. Examples of the “document(s)” include e-mails, presentation materials, spreadsheet materials, meeting materials, contracts, organization charts, and business plans.

A “word(s)” means a minimum set of character strings having a meaning. For example, a sentence stating “a document(s) is data including more than one words” includes words “document(s),” “is,” “data,” “including,” “more than,” “one,” and “words.”

A “keyword(s)” means a set of character strings having a certain meaning in a certain language. For example, when selecting keywords from a phrase “to classify documents,” the keywords may be “documents” and “classify.” In an embodiment, keywords such as “infringement,” “lawsuit,” and “Patent Publication No.” are selected intensively.

In this embodiment, it is assumed that keywords include morphemes.

Furthermore, “keyword-corresponding information” indicates the correspondence relationship between a keyword and a specific classification code. For example, if a classification code “important” indicating important documents in a lawsuit is closely related to a keyword “infringer,” the “keyword-corresponding information” is information for managing the classification code “important” and the keyword “infringer” by linking them together.

A “related term(s)” is a word whose evaluation value is equal to or more than a certain value, among words which appear at high appearance frequency commonly in documents to which a specified classification code is assigned. For example, the appearance frequency means a proportion of appearances of the related term to a total number of words which appear in one document.

Furthermore, an “evaluation value” means an amount of information which each word exhibits in a certain document. The “evaluation value” may be calculated based on a transmitted information amount. For example, if a specified product name is assigned as a classification code, “related terms” may indicate, for example, the name of a technical field to which the relevant product belongs, a country of sale of the relevant product, and the name(s) of a product(s) similar to the relevant product. Specifically speaking, when a product name of a device for executing image coding processing is assigned as a classification code, examples of the “related terms” include “coding processing,” “Japan,” and “encoder.”

“Related-term-corresponding information” indicates the correspondence relationship between a related term and a classification code. For example, when a classification code “Product A” which is a product name related to a lawsuit has a related term “image coding” which is a function of Product A, the “related-term-corresponding information” is information that manages the classification code “Product A” and the related term “image coding” by linking them together.

A “score” is quantitative evaluation of the strength of linkage with a specified classification code in a certain document. In each embodiment of the present invention, for example, the score is calculated based on words appearing in a document and an evaluation value of each word by using the following expression (1).

Scr=Σᵢ₌₀^{N}i*(mᵢ*wgtᵢ²)/Σᵢ₌₀^{N}i*wgtᵢ² (1)

Scr: score of the relevant document
mᵢ: appearance frequency of i-th keyword or related term
wgtᵢ²: weight of i-th keyword or related term

Furthermore, the document investigation system according to the present invention may extract words which frequently appear in documents which share a common classification code assigned by the user. Then, the document investigation system may analyze types of the extracted words included in each document, the evaluation value of each word, and tendency information about the number of appearances with respect to each document and assign the common classification code to a document(s) having the same tendency as the analyzed tendency information from among documents which have not accepted any classification code from the classification code accepting and assigning unit 131.

The term “tendency information” herein used: is information that each document has and indicates the degree of similarity to documents to which the classification code is assigned; and is represented by the relevance with a specified classification code based on the types of words included in each document, the number of appearances, and the evaluation values of the words. For example, when each document is similar to a document, to which a specified classification code is assigned, with respect to the relevance with the specified classification code, these two documents are recognized as having the same tendency information. Furthermore, even if the types of words included are different, documents including a word of the same evaluation value at the same number of appearances may be recognized as documents having the same tendency.

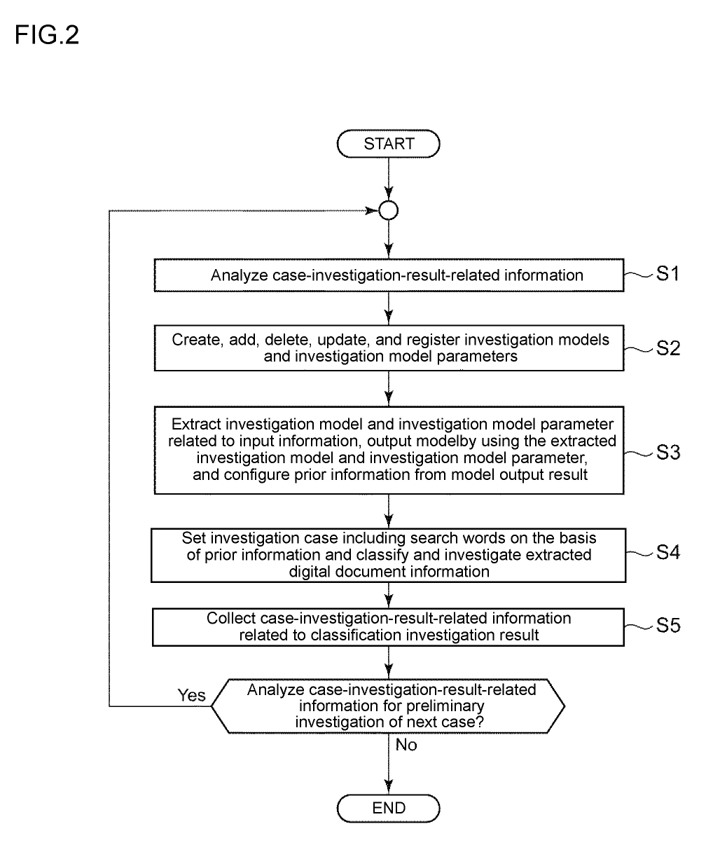

FIG. 2 illustrates a flowchart of a document investigation method according to an embodiment of the present invention. The document investigation method according to an embodiment of the present invention will be described below with reference to FIG. 2.

The case-investigation-result-related information is analyzed and the case-investigation-result-related information and the analysis result of the case-investigation-result-related information are registered in a database (STEP 1). A model and a model parameter are created, added, deleted, and updated and the relevant model and model parameter are registered in the database (STEP 2).

The database is searched in relation to input information such as a case type or an investigation type for specifying a case and investigation content, an investigation model and an investigation model parameter are extracted, a model is output by using the extracted investigation model and investigation model parameter, and prior information is configured of the model output result (STEP 3). The configured prior information may be registered in the database and used.

Investigation conditions including search words are set based on the prior information and the extracted digital document information is classified and investigated (STEP 4).

The case-investigation-result-related information related to the classification and investigation results is collected (STEP 5)

Then, when analyzing the case-investigation-result-related information for a new case and performing predictive classification, the processing from STEP 1 to STEP 5 is repeated for each case.

Regarding the document investigation method according to an embodiment of the present invention, analysis results of, for example, the case-investigation-result-related information about various cases are accumulated in the prior information configuration database. Various pieces of prior information can be provided to the new case from the accumulated analysis results of, for example, the case-investigation-result-related information.

Specifically speaking, the document investigation method according to an embodiment of the present invention makes it possible to classify and investigate documents on the basis of the provided prior information by configuring and outputting prior predictive information based on a specified investigation model by using the accumulated classification and investigation analysis results of the cases as an information source.

Incidentally, the investigation model parameter for defining a specified investigation model can be updated or modified by using the accumulated classification and investigation analysis results as the information source.

Basic processing of the document investigation method according to an embodiment of the present invention will be summarized and described below. Specifically speaking, by the document investigation method according to an embodiment of the present invention, the case-investigation-result-related information is collected and registered in the database.

The case-investigation-result-related information is read from the database and investigation models and investigation model parameters are updated or modified as appropriate.

An investigation model is configured with respect to input information for specifying the investigation content of a new case and prior information is provided based on the investigation model. As a result, it is possible to execute precise classification and investigation processing on the new case and obtain the benefit of enhancing reliability of the classification and investigation.

Processing for analyzing the case-investigation-result-related information (STEP 1 in FIG. 2) will be described below in detail by breaking it down to into processing of the following processing from STEP 11 to STEP 15.

The case-investigation-result-related information is collected (STEP 11).

The case-investigation-result-related information includes for example, the case type, the investigation type, the language type, bibliographic information about investigation target documents, statistic information, review-related information (such as protocols), review result information, predictive coding (PC) parameters and result information, and feedback information.

The case-investigation-result-related information is categorized or classified (STEP 12).

The case-investigation-result-related information is categorized by, for example, the case type or the investigation type. Information such as result information of predictive coding (PC) (analysis result information of, for example, morpheme analysis) is hierarchized and categorized.

The relation with existing information (miscellaneous information already stored in the relevant device) is examined (STEP 13).

The relation between information of, for example, the same or similar case types or investigation types is checked.

After the relation is checked, common information elements in the existing information and the related information are extracted according to the checked relation (STEP 14).

The common information elements include, for example, common morphemes and metadata.

The miscellaneous information related to the aforementioned common information elements is added, deleted, or updated (STEP 15).

The miscellaneous information related to the common information elements includes, for example, weight parameters of morphemes.

Processing for creating, adding, deleting, and updating, and registering an investigation model and an investigation model parameter (STEP 2 in FIG. 2) will be described below in detail by breaking it down into the following processing from STEP 21 to STEP 23.

The miscellaneous information related to the common information elements is read (STEP 21).

The aforementioned miscellaneous information is processed and information related to model parameters is generated (STEP 22).

An investigation model parameter is added, deleted, or updated based on the information related to the aforementioned investigation model parameters (STEP 23).

The aforementioned information about the investigation models and the investigation model parameters are registered in the database.

Processing for configuring the prior information (STEP 3 in FIG. 2) will be described below in detail by breaking it down into the following processing from STEP 31 to STEP 35.

Input information is collected (STEP 31).

The input information is information for specifically specifying a case and investigation content such as the case type and the investigation type. Furthermore, the input information may be, for example, identification information of a specific case.

Existing information related to the input information (miscellaneous information already stored in the relevant device) is extracted (STEP 32).

The above-described processing of STEP 32 may be executed according to steps STEP 13 and STEP 14 of the processing for analyzing the case-investigation-result-related information or on the basis of another relation.

An investigation model parameter related to the aforementioned existing information is extracted (STEP 33).

For example, an appropriate parameter of an investigation model relating to a specific investigation type may be determined. There are a plurality of investigation models, from which the investigation model may be selected as appropriate according to, for example, the investigation type.

A model output result is calculated based on the model by using the above-described investigation model parameter (STEP 34).

For example, the content indicating a typical characteristic act (fraudulent act, quasi-fraudulent act, or dangerous act) is derived from the investigation model on the basis of the information accumulated in the database DB with respect to a specified type.

The prior information is configured on the basis of the above-described investigation model output result (STEP 35).

The prior information is predictive information (such as a pattern of a fraudulent act or the like) corresponding to the input information.

After the prior information is configured, the processing proceeds with the classification and investigation on the basis of the prior information.

In the embodiment of the present invention, information relating to the prior information is used for the predictive coding, so that it may be stored in the prior information configuration database.

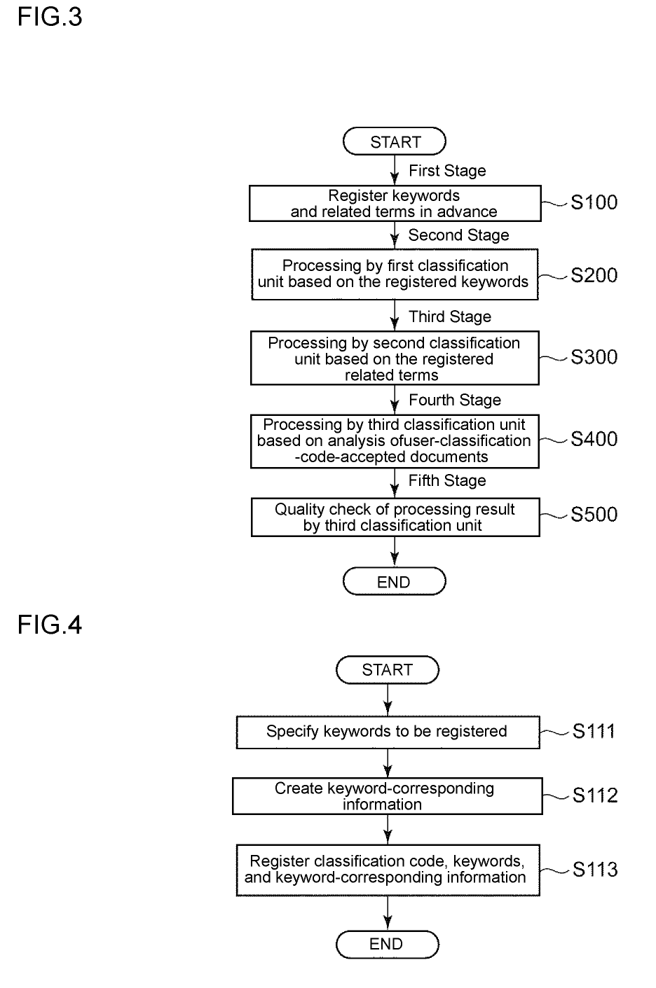

In the embodiment of the present invention, registration processing, classification processing, and check processing are executed from a first stage to a fifth stage according to a flowchart illustrated in FIG. 3.

In the first stage, keywords and related terms are updated and registered in advance by using the results of the classification processing in the past (STEP 100). When this happens, the keywords and the related terms are updated and registered together with the keyword-corresponding information and the related-term-corresponding information which are information indicative of the correspondence between the classification codes and the keywords or the related terms.

In the second stage, documents including the keywords which are updated and registered in the first stage are extracted from the entire document information; and when the relevant document is found, first classification processing for assigning a classification code corresponding to the relevant keyword is executed with reference to the updated keyword-corresponding information recorded in the first stage (STEP 200).

In the third stage, documents including the related terms updated and registered in the first stage are extracted from the document information, to which any classification code was not assigned in the second stage, and the score of the documents including the related terms is calculated. Second classification processing is executed for executing assignment of the classification code with reference to the calculated score and the related-term-corresponding information updated and registered in the first stage (STEP 300).

In the fourth stage, a classification code assigned by the user is accepted for document information to which any classification code was not assigned before and in the third stage; and the classification code accepted from the user is assigned to the relevant document information. Next, third classification processing is executed for analyzing the document information to which the classification code accepted from the user is assigned, extracting documents, to which no classification code is assigned, on the basis of the analysis result, and assigning classification codes to the extracted documents. For example, words which frequently appear in documents with a common classification code assigned by the user are extracted, tendency information included in each document about the types of the extracted words, and the evaluation value of each word and the number of appearances is analyzed for each document, and the common classification code is assigned to a document(s) having the same tendency as the tendency information (STEP 400).

In the fifth stage, a classification code to be assigned on the basis of the analyzed tendency information is determined with respect to the document(s) to which the user assigned the classification code in the fourth stage; and the validity of the classification processing is verified by comparing the determined classification code with the classification code assigned by the user (STEP 500). Furthermore, leaning processing may be executed based on the result of the document classification processing as the need arises.

The tendency information used for the processing in the fourth stage and the fifth stage is information that each document has, indicates the degree of similarity with documents to which the classification codes are assigned, and is based on the types of words included in each document, the number of appearances, and the evaluation values of the words. For example, when each document is similar to a document, to which a specified classification code is assigned, with respect to the relevance to the specified classification code, these two documents are recognized as having the same tendency information. Furthermore, even if the types of words included are different, documents including a word of the same evaluation value with the same number of appearances may be recognized as documents having the same tendency.

A detailed processing flow of each stage from the first stage to the fifth stage will be explained below.

<First Stage (STEP 100)>

A detailed processing flow of the keyword database 104 in the first stage will be explained with reference to FIG. 4.

The keyword database 104 creates a management table for each classification code in light of document classification results in lawsuits in the past and specifies keywords corresponding to each classification code (STEP 111). This specification is conducted in the embodiment of the present invention by analyzing documents to which each classification code is assigned, and using the number of appearances of each keyword and the evaluation value of each keyword in such documents; and, for example, a method of using a transmitted information amount that the keyword has, or a method of manual selection by the user may also be used.

In the embodiment of the present invention, for example, when keywords “infringement” and “patent lawyer” are specified as keywords for the classification code “important,” keyword-corresponding information indicating that “infringement” and “patent lawyer” are keywords closely related to the classification code “important” is created (STEP 112). Then, the specified keywords are registered in the keyword database 104. When this happens, the specified keywords are associated with the keyword-corresponding information and are recorded in the management table for the classification code “important” in the keyword database 104 (STEP 113).

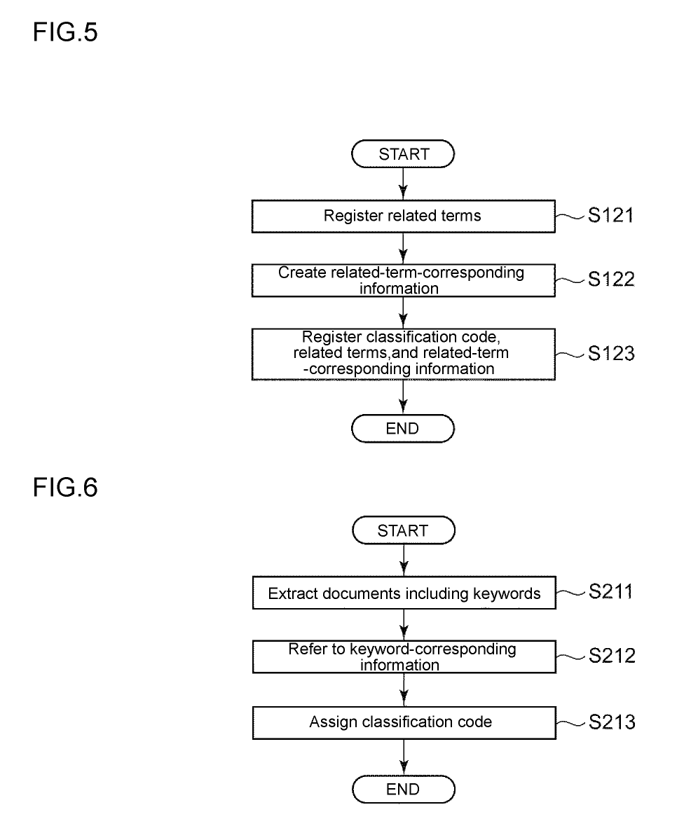

Next, a detailed processing flow of the related term database 105 will be explained with reference to FIG. 5. The related term database 105 creates a management table for each classification code in light of document classification results in lawsuits in the past and registers related terms corresponding to each classification code (STEP 121). In the embodiment of the present invention, for example, “coding processing” and “Product a” are registered as related terms of “Product A” and “decoding” and “Product b” are registered as related terms of “Product B.”

The related-term-corresponding information indicating to which classification code each of the registered related terms corresponds is created (STEP 122) and is recorded in each management table (STEP 123). When this happens, a threshold value which is a necessary score to determine the evaluation value and classification code of each related term is also recorded in the related-term-corresponding information.

Before actually conducting classification work, the keywords and the keyword-corresponding information as well as the related terms and the related-term-corresponding information are updated to the latest data and registered (STEP 113 and STEP 123).

<Second Stage (STEP 200)>

A detailed processing flow of the first automatic classification unit 201 in the second stage will be explained with reference to FIG. 6. In the second stage in the embodiment of the present invention, the first automatic classification unit 201 executes processing for assigning the classification code “important” to documents.

The first automatic classification unit 201 extracts the documents including the keywords “infringement” and “patent lawyer,” which were registered in the keyword database 104 in the first stage (STEP 100), from the document information (STEP 211). The first automatic classification unit 201 refers to the management table, in which the relevant keywords are recorded, based on the keyword-corresponding information (STEP 212) and assigns the classification code “important” to the extracted documents (STEP 213).

<Third Stage (STEP 300)>

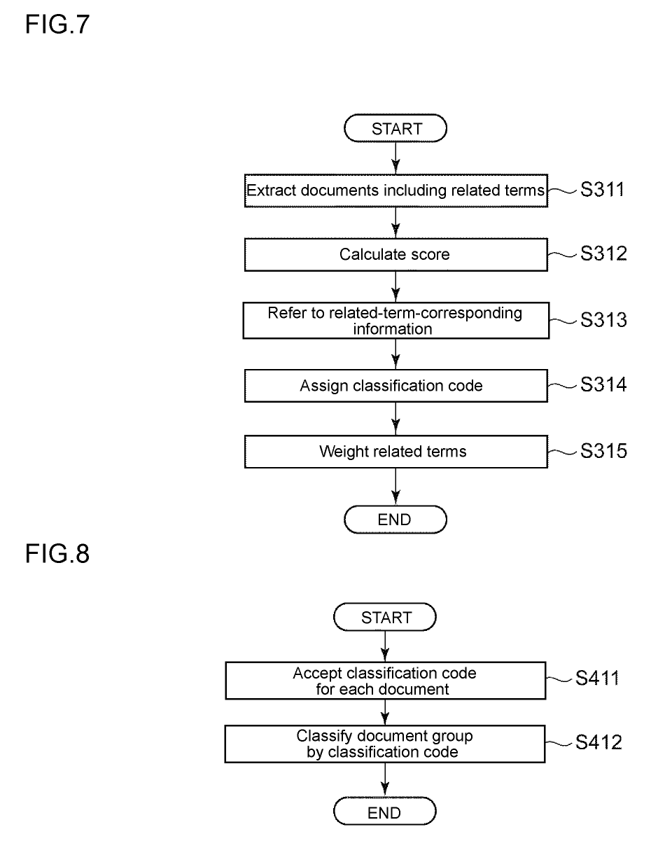

A detailed processing flow of the second automatic classification unit 301 in the third stage will be explained with reference to FIG. 7.

In the embodiment of the present invention, the second automatic classification unit 301 executes processing for assigning classification codes “Product A” and “Product B” to the document information to which no classification code was assigned in the second stage (STEP 200).

The second automatic classification unit 301 extracts documents including the related terms “coding processing,” “Product a,” “decoding,” and “Product b,” which were recorded in the related term database 105 in the first stage, from the relevant document information (STEP 311). The score calculation unit 116 calculates a score based on the appearance frequency and evaluation values of the recorded four related terms with respect to the extracted documents by using the expression (1) (STEP 312). The score represents the relevance between each document and the classification codes “Product A” and “Product B.”

When the score exceeds the threshold value, the second automatic classification unit 301 refers to the related-term-corresponding information (STEP 313) and assigns an appropriate classification code (STEP 314).

For example, if in a certain document the appearance frequency of the related terms “coding processing” and “Product a” and the evaluation value of the related term “coding processing” are high and the score indicative of the relevance with the classification code “Product A” exceeds the threshold value, the classification code “Product A” is assigned to the relevant document.

When this happens, if the appearance frequency of the related term “Product b” in the relevant document is also high and the score indicative of the relevance with the classification code “Product B” exceeds the threshold value, “Product B” is also assigned, together with the classification code “Product A,” to the relevant document. On the other hand, if the appearance frequency of the related term “Product b” in the relevant document is low and the score indicative of the relevance with the classification code “Product B” does not exceed the threshold value, only the classification code “Product A” is assigned to the relevant document.

The second automatic classification unit 301 recalculates the evaluation value of the related term according to the expression (2) indicated below by using the score calculated in STEP 432 of the fourth stage and weights the evaluation value (STEP 315).

wgt_{i,L}=\sqrt{wgt_{L-i}²+γ_{L}wgt_{i,L}²−∂}={square root over (wgt_{i,L}²+Σₗ₌₁^{L}(γₗwgt_{i,l}²−∂)} (2)

Wgt_{i,0}: weight (initial value) of i-th selected keyword before learning
Wgt_{i,L}: weight of i-th selected keyword after L-th learning
γ_{L}: learning parameter for L-th learning
θ: threshold value of learning effect

For example, if there are a certain number or more of documents regarding which the appearance frequency of “decoding” is high, but the score is lower than a certain value, the evaluation value of the related term “decoding” is decreased and then recorded in the related-term-corresponding information again.

<Fourth Stage (STEP 400)>

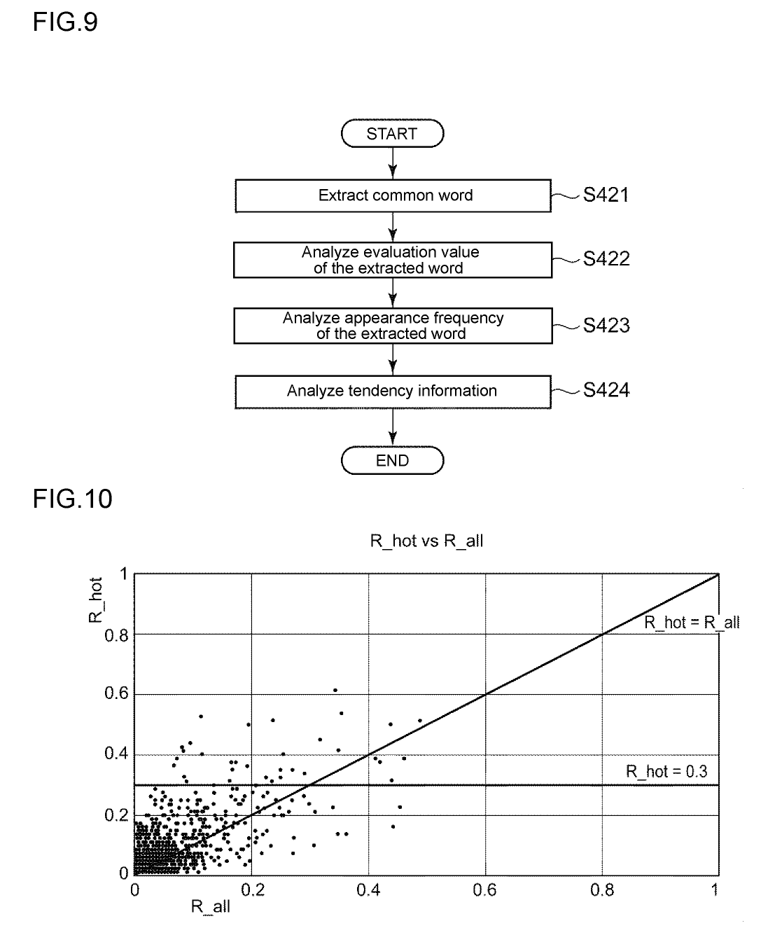

In the fourth stage as illustrated in FIG. 8, assignment of the classification codes from the reviewer is accepted with respect to a certain proportion of document information extracted from the document information to which no classification code was assigned before or in the third stage; and the accepted classification codes are assigned to the relevant document information. Next, referring to FIG. 9, the document information to which the classification codes accepted from the reviewer is analyzed and the classification codes are assigned to the document information, to which no classification code is assigned, on the basis of the analysis result. Incidentally, in the embodiment of the present invention, processing for assigning, for example, the classification codes “important,” “Product A,” and “Product B” to the relevant document information is executed in the fourth stage. The fourth stage will be further explained below.

A detailed processing flow of the classification code accepting and assigning unit 131 in the fourth stage will be explained with reference to FIG. 8. The document extracting unit 112 firstly randomly samples documents from the document information, which is a processing target in the fourth stage, and displays them on the document display unit 130. In the embodiment of the present invention, documents which are 20% of the processing-target document information are randomly extracted and become targets to be classified by the reviewer. Sampling may be conducted by an extraction method of arranging the documents in the order of document creation dates and times or in the order of their names and selecting top 30% documents.

The user browses the display screen 11 displayed on the document display unit 130 as illustrated in FIG. 14 and selects a classification code to be assigned to each document. The classification code accepting and assigning unit 131 accepts the classification code selected by the user (STEP 411) and performs classification on the basis of the assigned classification code (STEP 412).

Next, a detailed processing flow of the document analysis unit 118 will be explained with reference to FIG. 9. The document analysis unit 118 extracts a word(s) which frequently appears commonly in the documents classified by each classification code by the classification code accepting and assigning unit 131 (STEP 421). The evaluation value of the extracted common word is analyzed according to the expression (2) (STEP 422) and the appearance frequency of the common word in the documents is analyzed (STEP 423).

Furthermore, based on the analysis result in STEP 422 and STEP 423, the tendency information of the documents to which the classification code “important” is assigned is analyzed (STEP 424).

FIG. 10 is a graph illustrating the analysis result of words which frequently appear commonly in the documents, to which the classification code “important” is assigned, in STEP 424.

Referring to FIG. 10, the vertical axis R_hot represents a proportion of documents which include words selected as words linked to the code “important” and to which the code “important” is assigned, to all the documents to which the code “important” assigned by the user. The horizontal axis represents a proportion of documents including the words extracted by the classification code accepting and assigning unit 131 from among all the documents, on which the user has executed the classification processing, in STEP 421.

In the embodiment of the present invention, the classification code accepting and assigning unit 131 extracts words like those plotted above a straight line R_hot=R_all as common words for the classification code “important.”

The processing in STEP 421 to STEP 424 is also executed on documents to which the classification codes “Product A” and “Product B” are assigned; and the tendency information of the relevant documents is analyzed.

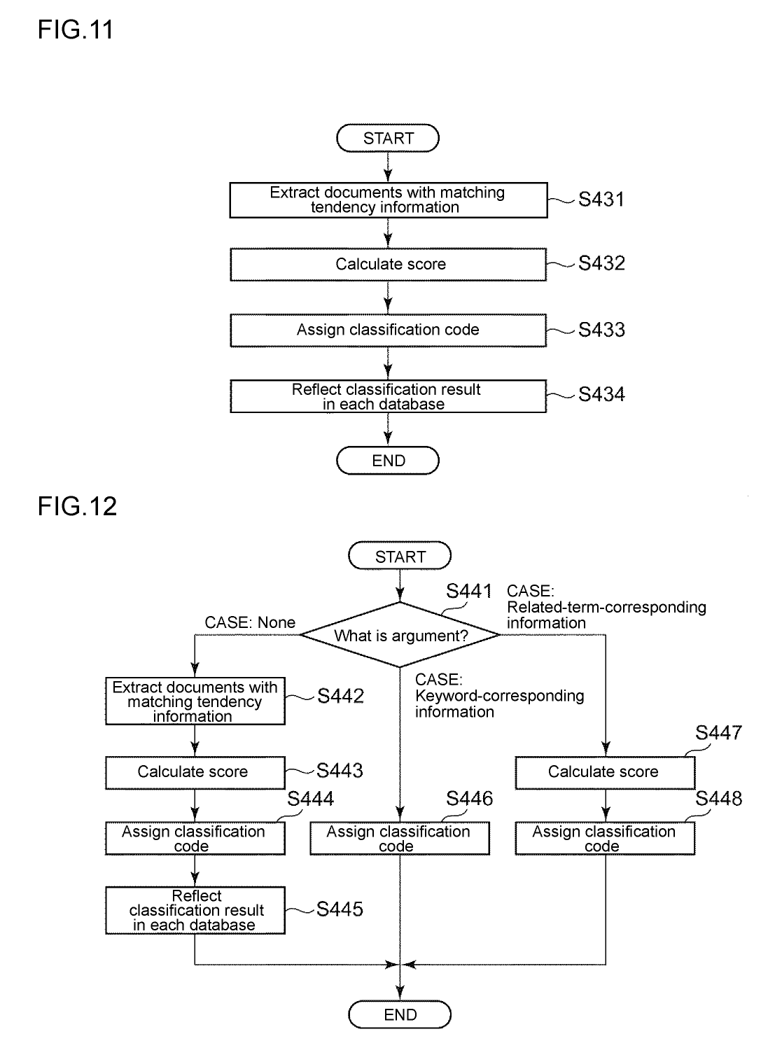

Next, a detailed processing flow of the third automatic classification unit 401 will be explained with reference to FIG. 11. The third automatic classification unit 401 executes processing on documents, to which the assignment of classification codes was not accepted by the classification code accepting and assigning unit 131 in STEP 411, from among the document information which is the processing target in the fourth stage. The third automatic classification unit 401 extracts documents having the same tendency information as the tendency information of the documents, to which the classification code “important,” “Product A,” and “Product B” are assigned and analyzed in STEP 424, from the above-described documents (STEP 431) and calculates the score with respect to the extracted documents on the basis of the tendency information by using the expression (1) (STEP 432). Furthermore, the third automatic classification unit 401 assigns appropriate classification codes to the documents extracted in STEP 431 on the basis of the tendency information (STEP 433).

The third automatic classification unit 401 further reflects the classification result in each database by using the score calculated in STEP 432 (STEP 434). Specifically speaking, processing for decreasing the evaluation values of the keywords and the related terms included in documents with a low score, and increasing the evaluation values of the keywords and the related terms included in documents with a high score may be executed.

Furthermore, one example of a detailed processing flow of the third automatic classification unit 401 will be explained with reference to FIG. 12. The third automatic classification unit 401 may execute classification processing on documents, regarding which the assignment of classification codes was not accepted by the classification code accepting and assigning unit 131 in STEP 411, from among the document information which is the processing target in the fourth stage. When an argument is not given (STEP 441: None), the third automatic classification unit 401 extracts documents having the same tendency information as the tendency information of the documents, to which the classification code “important” is assigned and which were analyzed in STEP 424, from the relevant documents (STEP 442) and calculates the score with respect to the extracted documents on the basis of the tendency information by using the expression (1) (STEP 443). Furthermore, the third automatic classification unit 401 assigns appropriate classification codes to the documents extracted in STEP 442 on the basis of the tendency information (STEP 444).

The third automatic classification unit 401 further reflects the classification result in each database by using the score calculated in STEP 443 (STEP 445). Specifically speaking, the third automatic classification unit 401 executes processing for decreasing the evaluation values of the keywords and the related terms included in documents with a low score, and increasing the evaluation values of the keywords and the related terms included in documents with a high score.

The score calculation is performed by both the second automatic classification unit 301 and the third automatic classification unit 401 as described above; and when the number of times of the score calculation is high, data for the score calculation may be collectively stored in the score calculation database 106.

<Fifth Stage (STEP 500)>

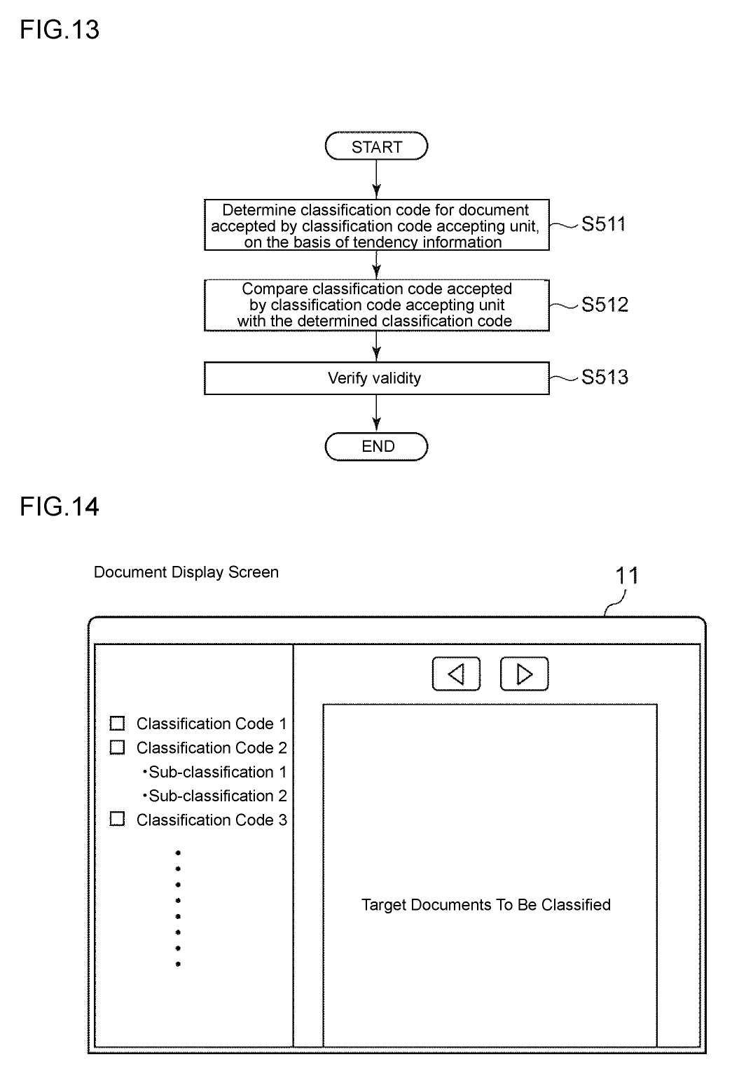

A detailed processing flow of the quality checking unit 501 in the fifth stage will be explained with reference to FIG. 13. The quality checking unit 501 determines a classification code to be assigned to the documents accepted by the classification code accepting and assigning unit 131 in STEP 411 on the basis of the tendency information analyzed by the document analysis unit 118 in STEP 424 (STEP 511). The quality checking unit 501 compares the classification code accepted by the classification code accepting and assigning unit 131 with the classification code determined in STEP 511 (STEP 512) and verifies the validity of the classification code accepted in STEP 411 (STEP 513).

The document investigation system 1 according to the embodiment of the present invention may be equipped with the learning unit 601. The learning unit 601 learns weighting of each keyword or related term according to the expression (2) on the basis of the first to fourth processing results. The learning result may be reflected in the keyword database 104, the related term database 105, or the score calculation database 106.

The document investigation system 1 according to the embodiment of the present invention is equipped with the report preparation unit 701 that outputs an optimum investigation report according to the investigation type of the relevant lawsuit case (for example, in a case of lawsuits, cartel, patent, FCPA, and PL lawsuits) or the fraud investigation (such as information leakage or billing fraud) on the basis of the result of the document classification processing.

The investigation content varies depending on the investigation type.

For example, in a cartel case, key points will be:

1. when and how persons in charge of competitors communicated with each other in relation to the cartel (for adjustment of prices); and
2. who in which organizations are the persons concerned.

Furthermore, in a case of patent infringement, key points will be:

1. whether or not its content is the same as a technique that is an infringement object; and
2. who made, or did not make, the infringement and when, and with (or without) what intention the infringement was made.

Accordingly, the investigation content will vary depending on the investigation type or category.

In the embodiment of the present invention, a report is prepared automatically according to the investigation type and the investigation content even if the investigation type and the investigation content vary.

Other examples of the embodiment of the present invention will be described below. In another example of the embodiment of the present invention, a method of analyzing documents, to which classification codes have already been assigned, according to similar search information and adjusting the range to assign the classification codes on the basis of the analysis result is used.

As the method of adjusting the range to assign the classification codes according to the similar search information, there are a method of adjusting the range to assign the classification codes by clustering the similar search information according to the similar search information, and a method of performing predictive classification by learning the classification result. Regarding the method of adjusting the range to assign the classification codes by clustering the similar search information according to the similar search information, there is a case, for example, in which attention is focused on commonality of metadata and a common classification code is assigned to an original document, a response document of the original document, and a response document of the response document of the original document. Regarding the method of performing the predictive classification by learning the classification result, the same or similar classification code is assigned with respect to the similar search information by learning the classification result so as to integrate the similar search information.

In another example of the embodiment of the present invention, reliability of the analysis result changes depending on the number of documents which become analysis objects. At which time and to which proportion of all the documents the range to assign the classification codes should be adjusted on the basis of the analysis result may be determined by applying a statistic means to the total number of documents which become objects to be classified.

In another example of the embodiment of the present invention, as the method of adjusting the range to assign the classification codes according to the similar search information, the range of documents to assign the classification codes may be adjusted by executing both the method of adjusting the range to assign the classification codes by clustering the search information according to the similar search information and the method of performing the predictive classification by learning the classification result. As a result, in the other examples of the embodiment of the present invention, it is possible to assign the classification codes promptly and precisely and reduce the burdens caused by the classification work.

### Advantageous Effects of Embodiment of the Present Invention

With the document investigation system, document investigation method, and document investigation program for providing the prior information according to the present invention, information which has been accumulated and obtained from lawsuit cases or fraud investigation cases in the past is collected and analyzed as the prior information depending on a lawsuit case or a fraud investigation case and classification work and investigation work are conducted with respect to the document information to be used for the lawsuit or fraud investigation on the basis of the analyzed information, thereby making it possible to conduct precise and reliable classification and investigations.

Furthermore, with the document investigation system, document investigation method, and document investigation program for providing the prior information according to the present invention, information which has been accumulated and obtained from lawsuit cases or fraud investigation cases in the past is collected and analyzed as the prior information depending on a lawsuit case or a fraud investigation case and classification work and investigation work are conducted with respect to the document information to be used for the lawsuit or fraud investigation on the basis of the analyzed information, thereby making it possible to reduce burdens on the classification work and investigate work conducted with respect to the relevant document information.

### REFERENCE SIGNS LIST

1 document investigation system
201 first automatic classification unit
301 second automatic classification unit
401 third automatic classification unit
501 quality checking unit
601 learning unit
701 report preparation unit
801 investigation result analysis unit
100 data storage unit
101 digital information storage area
103 investigation result database
104 keyword database
105 related term database
106 score calculation database
107 prior information configuration database
109 database management unit
112 document extracting unit
114 word searching unit
116 score calculation unit
118 document analysis unit
120 prior information configuration unit
122 translation unit
124 tendency information generation unit
130 document display unit
131 classification code accepting and assigning unit
133 lawyer's review accepting unit
11 document display screen

1. A document investigation system for acquiring digital information recorded in a plurality of computers or servers, analyzing document information composed of a plurality of documents included in the obtained digital information, and providing prior information to investigate relevance with a lawsuit or fraud investigation in order to make it easier to use the document information for the lawsuit or the fraud investigation,
the document investigation system for providing the prior information, comprising:
an investigation result analysis unit that collects and analyzes case-investigation-result-related information including a classification work result of each case with respect to a lawsuit or fraud investigation case, prepares or updates an investigation model parameter to investigate the lawsuit or fraud investigation case, and registers the investigation model parameter; and
a prior information configuration unit that, after accepting input information for specifying investigation content of a new investigation case, searches for the registered investigation model parameter, extracts an investigation model parameter in relation to the input information, outputs an investigation model by using the extracted investigation model parameter, and configures and provides the prior information to investigate the new investigation case based on an investigation model output result.

2. The document investigation system for providing the prior information according to claim 1, further comprising a data storage unit that stores an investigation result database for registering information related to a classification and investigation result of each case,
wherein the investigation result analysis unit collects and analyzes the case-investigation-result-related information including a case type, an investigation type, a language type, a classification work result, and a predictive classification work result of each case with respect to the lawsuit or fraud investigation case of the investigation result analysis unit, creates or updates the investigation model parameter and the investigation model to investigate the lawsuit or fraud investigation case on the basis of an analysis result of the investigation-result-related information, and registers the case-investigation-result-related information, the analysis result of the case-investigation-result-related information, the investigation model parameter, and the investigation model in the investigation result database; and
wherein after accepting the input information for specifying the investigation content of the new investigation case, the prior information configuration unit searches the investigation result database, extracts the investigation model and the investigation model parameter from the investigation result database in relation to the input information, outputs the investigation model by using the extracted investigation model and the investigation model parameter, and configures the prior information from the investigation model output result to investigate the new investigation case.

3. The document investigation system for providing the prior information according to claim 1, wherein the investigation result analysis unit analyzes the case-investigation-result-related information by investigating a relation between the collected case-investigation-result-related information and the registered case-investigation-result-related information, extracting a common information element from the collected case-investigation-result-related information and the registered case-investigation-result-related information, and adding, deleting, or updating common-information-element-related information which is related to the common information element and includes a weighting parameter of a morpheme of the case.

4. The document investigation system for providing the prior information according to claim 3, wherein the investigation result analysis unit processes the common-information-element-related information and generates or updates information related to the investigation model parameter.

5. A document investigation method for acquiring digital information recorded in a plurality of computers or servers, analyzing document information composed of a plurality of documents included in the obtained digital information, and providing prior information to investigate relevance with a lawsuit or fraud investigation in order to make it easier to use the document information for the lawsuit or the fraud investigation,
wherein the computers:
collect and analyze case-investigation-result-related information including a classification work result of each case with respect to a lawsuit or fraud investigation case, prepare or update an investigation model parameter to investigate the lawsuit or fraud investigation case, and register the investigation model parameter; and
after accepting input information for specifying investigation content of a new investigation case, search for the registered investigation model parameter, extracts an investigation model parameter in relation to the input information, output an investigation model by using the extracted investigation model parameter, and configure and provide the prior information to investigate the new investigation case based on an investigation model output result.

6. A document investigation program for acquiring digital information recorded in a plurality of computers or servers, analyzing document information composed of a plurality of documents included in the obtained digital information, and providing prior information to investigate relevance with a lawsuit or fraud investigation in order to make it easier to use the document information for the lawsuit or the fraud investigation,
wherein the document investigation program has the computers implement:
a function that collects and analyzes case-investigation-result-related information including a classification work result of each case with respect to a lawsuit or fraud investigation case, prepares or updates an investigation model parameter to investigate the lawsuit or fraud investigation case, and registers the investigation model parameter; and a function that, after accepting input information for specifying investigation content of a new investigation case, searches for the registered investigation model parameter, extracts an investigation model parameter in relation to the input information, outputs an investigation model by using the extracted investigation model parameter, and
configures and provides the prior information to investigate the new investigation case based on an investigation model output result.
